(19) United States
(12) Patent Application Publication
(10) Pub. No.: US 2013/0002830 A1
(43) Pub. Date: Jan. 3, 2013

(54) STEREOSCOPIC IMAGING DEVICE AND METHOD FOR AUTOMATICALLY ADJUSTING THE FOCAL POINT OF A STEREOSCOPIC IMAGING DEVICE

(76) Inventor: Yi Pan, Saitama-shi (JP)

(21) Appl. No.: 13/634,226

(22) PCT Filed: Nov. 11, 2010
(86) PCT No.: PCT/JP2010/070098

§ 371 Date: Sep. 11, 2012

(30) Foreign Application Priority Data
Mar. 25, 2010 (JP) 2010 070292

(51) Int. Cl. H04N 13/02

(52) U.S. Cl. 348/49; 348/E13.074

(57) ABSTRACT

A stereoscopic imaging device comprising: a second focus adjusting unit that operates a second focus lens to carry out a search within a second search range and searches for a second lens position at which a subject to be imaged is brought into focus; and a photographing unit that performs a photographing of a first viewpoint image and a second viewpoint image when a photographing instruction is inputted after a process by a first focus adjusting unit and a second focus adjusting unit, wherein the second focus adjusting unit calculates the second lens position based upon a first lens position and a focus positional deviation amount stored in a storage unit, and shifts the second focus lens to the second lens position, if it is not possible to acquire the second lens position within the second search range as a result of the search.

### TECHNICAL FIELD

The contents of the present disclosure relate to a stereoscopic imaging device and a method for automatically adjusting the focal point of the stereoscopic imaging device, and in particular concern a technique for efficiently searching for focusing positions of two imaging units with high focusing precision.

### BACKGROUND ART

Conventionally, many stereoscopic imaging devices, each having two imaging units, have been proposed (see Patent Literatures 1 and 2). In the stereoscopic imaging device, a stereoscopic image capturing operation in which an identical subject is image-captured from different viewpoints by using two imaging units can be carried out, and a panoramic image capturing operation with an ultrawide angle, image capturing processes with different sensitivities respectively carried out by two imaging units, and the like, can also be carried out.

In the device that carries out stereoscopic image capturing operations by using two imaging units, the two imaging units are arranged side by side at positions corresponding to the right eye and left eye with a parallax, and based upon image signals outputted from the two imaging units, an image signal for right eye and an image signal for left eye are respectively generated in a signal processing unit in the succeeding stage. Thus, when the image signal for right eye and the image signal for left eye generated in the signal processing unit in the stereoscopic imaging device are inputted to a display device having a display screen capable of providing a stereoscopic display, a stereoscopic image is displayed on the display screen.

On the other hand, in the digital camera, upon executing focus adjustments, that is, adjustments in focusing positions, an automatic focus adjusting unit installed therein shifts a focus lens in the imaging optical system within a predetermined search range, and during a period in which the focus lens is being shifted, a contrast of an image being captured is detected, and the focus lens is shifted to a focusing position (lens position) that maximizes the contrast; thus, a so-called contrast AF (Auto Focus) operation is carried out in most cases.

In the stereoscopic imaging device of the above-mentioned Patent Literature 1, because of the fact that the two imaging units capture an identical subject, a contrast AF operation is executed only in one of the imaging units, and by also using the result of the contrast AF operation for the other imaging unit, an attempt is made to shorten a period of time required for the contrast AF operation of the imaging device with the two imaging units. Moreover, in the stereoscopic imaging device of Patent Literature 2, a technique has been proposed in which an AF search in which the focus lenses possessed by the two imaging units are respectively shifted in mutually reversed directions is carried out, and of the two imaging units, the AF search result of the one that has detected a focusing position earlier than the other is used so as to determine focusing positions of the two imaging units.

### CITATION LIST

### Patent Literature

PTL 1: Japanese Patent Application Laid-Open No. 2005-45511
PTL 2: Japanese Patent Application Laid-Open No. 2006-162990

### SUMMARY OF INVENTION

### Technical Problem

However, in the two imaging units, deviations and the like in the lens diameters of focus lenses, the lens barrel diameters and the light receiving sensitivities of imaging elements inevitably exist (which are generally referred to as individual differences in the following description). For this reason, when an arrangement is used in which the focusing position of one of the imaging units is also used as a focusing position for the other imaging unit as in the case of Patent Literatures 1 and 2, a problem arises in which a deviation occurs in the focusing position of the other imaging unit due to the individual differences of devices.

If AF operations are carried out individually in the respective imaging units, although the problem with individual differences of the two imaging units can be solved, another problem of poor efficiency is raised.

In view of the above identified circumstances, it is therefore an object of the contents of the present disclosure to provide a stereoscopic imaging device that can effectively carry out AF operations in two imaging units and also execute focus adjusting processes with high focusing precision even when there are individual differences in the two imaging units, and a method for automatically adjusting the focal point of such a device.

### Solution to Problems

In order to achieve the object, a stereoscopic imaging device according to a first aspect is provided with: a first imaging unit having a first imaging optical system including a first focus lens and a first imaging element that photoelectrically converts subject light to be imaged through the first imaging optical system, and outputs a first viewpoint image; a second imaging unit having a second imaging optical system including a second focus lens and a second imaging element that photoelectrically converts subject light to be imaged through the second imaging optical system, and outputs a second viewpoint image; a storage unit that preliminarily stores a focus positional deviation amount between a first lens position of the first focus lens and a second lens position of the second focus lens at the time of focusing on an identical subject; and a focus adjusting unit that operates the first focus lens to carry out a search within a predetermined first search range so as to search for a first lens position at which a subject to be imaged is brought into focus based upon the first viewpoint image acquired from the first imaging unit, shifts the first focus lens to the first lens position, and with respect to the second imaging optical system, operates the second focus lens to carry out a search within a second search range narrower than the first search range that is located before and after the lens position of the second focus lens, and corresponds to the first lens position that has been searched for, and based upon the second viewpoint image acquired from the second imaging unit, searches for a second lens position at which the subject to be imaged is brought into focus to shift the second focus lens to the second lens position, and in this structure, if the second lens position is not searched for within the second search range, the focus adjusting unit calculates the second lens position based upon the first lens position and the focus positional deviation amount stored in the storage unit to shift the second focus lens to the second lens position.

In accordance with the stereoscopic imaging device relating to the first aspect, with respect to the first imaging optical system, the first focus lens is operated to carry out a search within a predetermined first search range so as to search for a first lens position at which a subject to be imaged is brought into focus to shift the first focus lens to the first lens position, and with respect to the second imaging optical system, the second focus lens is operated to carry out a search within a second search range narrower than the first search range that is located before and after the lens position of the second focus lens, and corresponds to the first lens position that has been searched for so as to search for a second lens position at which the subject to be imaged is brought into focus, and the second focus lens is subsequently shifted to the second lens position; therefore, the focusing process can be carried out without being influenced by individual differences of the first and second imaging units, and by utilizing the focusing position (first lens position) first searched for, the second search range of the second focus lens is made narrower than the first focus range so that it is possible to carry out a search for the focusing position (second lens position) of the second focus lens in a shorter period of time.

Moreover, if it is not possible to search for the second lens position within the second search range, the second lens position is calculated based upon the first lens position obtained by the search for the first focus lens and the focus positional deviation amount stored in the storage unit to shift the second focus lens to the second lens position; therefore, the focusing process can be carried out without being influenced by individual differences of the first and second imaging units.

A stereoscopic imaging device according to a second aspect is provided with a first imaging unit having a first imaging optical system including a first focus lens and a first imaging element that photoelectrically converts subject light to be imaged through the first imaging optical system, and outputs a first viewpoint image; a second imaging unit having a second imaging optical system including a second focus lens and a second imaging element that photoelectrically converts subject light to be imaged through the second imaging optical system, and outputs a second viewpoint image; and a focus adjusting unit that operates the first focus lens to carry out a search within a predetermined first search range so as to search for a first lens position at which a subject to be imaged is brought into focus based upon the first viewpoint image acquired from the first imaging unit, shifts the first focus lens to the first lens position, and with respect to the second imaging optical system, operates the second focus lens to carry out a search within a second search range narrower than the first search range that is located before and after the lens position of the second focus lens, and corresponds to the first lens position that has been searched for, and based upon the second viewpoint image acquired from the second imaging unit, searches for a second lens position at which the subject to be imaged is brought into focus to shift the second focus lens to the second lens position, and if the second lens position is not searched for within the second search range, the focus adjusting unit again operates the second focus lens to carry out a search within a third search range wider than the second search range, and searches for a second lens position at which a subject to be imaged is brought into focus based upon the second viewpoint image acquired from the second imaging unit to shift the second focus lens to the second lens position.

The stereoscopic imaging device in accordance with the second aspect is different from the stereoscopic imaging device of the first aspect in an operation that is carried out when the second lens position corresponding to a focusing position of the second focus lens cannot be searched for, and the stereoscopic imaging device of the second aspect operates the second focus lens to again carry out a search within a third search range that is wider than the second search range for use in searching for the second lens position to shift the second locus lens to this second lens position. Additionally, the third search range may have the same size as the first search range, or may have a size that is narrower than the first search range, but wider than the second search range.

In accordance with a third aspect, the stereoscopic imaging device relating to the second aspect is further provided with: a storage unit that preliminarily stores a focus positional deviation amount between a first lens position of the first focus lens and a second lens position of the second focus lens at the time of focusing on an identical subject, and in this structure, if the second lens position is not searched for within the third search range, the focus adjusting unit calculates the second lens position based upon the first lens position searched for and the focus positional deviation amount stored in the storage unit to shift the second focus lens to the second lens position.

In other words, if it is not possible to search for the second lens position (focusing position) even within the third search range with a wider search range than the second search range, the second lens position is calculated based upon the first lens position and the focus positional deviation amount stored in the storage unit to shift the second focus lens to the second lens position. With this arrangement, the focusing process can be carried out without being influenced by individual differences of the first and second imaging units.

In accordance with a fourth aspect, the stereoscopic imaging device relating to the second aspect is further provided with: a storage unit that preliminarily stores a focus positional deviation amount between a first lens position of the first focus lens and a second lens position of the second focus lens at the time of focusing on an identical subject; and a calculation unit that calculates a differential value between the first lens position searched for within the first search range and the second lens position searched for within the third search range, and in this structure, if a differential value calculated by the calculation unit is greater than a predetermined amount, the focus adjusting unit calculates the second lens position based upon the first lens position searched for and the focus positional deviation amount stored in the storage unit to shift the second focus lens the second lens position calculated in place of the second lens position searched for within the third search range.

In other words, even if it is not possible to search for the second lens position within the third search range with a wider search range, if the differential value between the first lens position and the second lens position respectively searched for is greater than a predetermined amount, the second lens position is calculated based upon the first lens position and the focus positional deviation amount stored in the storage unit to shift the second focus lens to the second lens position. With this arrangement, it is possible to prevent the first and second imaging units from focusing on respectively different subjects.

In accordance with a fifth aspect, the stereoscopic imaging device relating to the second aspect is further provided with: a storage unit that preliminarily stores a focus positional deviation amount between a first lens position of the first focus lens and a second lens position of the second focus lens at the time of focusing on an identical subject; and a calculation unit that calculates a differential value between the first lens position searched for within the first search range and the second lens position searched for within the third search range, and in this structure, if a differential value calculated by the calculation unit is greater than a predetermined amount, the focus adjusting unit calculates the first lens position based upon the second lens position searched for and the focus positional deviation amount stored in the storage unit to shift the first focus lens to the first lens position calculated in place of the first lens position searched for within the first search range.

That is, if the differential value between the first lens position and the second lens position respectively searched for is greater than a predetermined amount, the stereoscopic imaging device in accordance with the fifth aspect calculates the first lens position based upon the second lens position searched for and the focus positional deviation amount stored in the storage unit in a manner reversed to that of the stereoscopic imaging device relating to the fourth aspect, to shift the first focus lens to the first lens position calculated. With this arrangement, it is possible to prevent the first and second imaging units from focusing on respectively different subjects.

In accordance with a sixth aspect, the stereoscopic imaging device relating to the fourth or fifth aspect has a structure in which the predetermined amount is determined based upon the focus positional deviation amount.

In accordance with a seventh aspect, the stereoscopic imaging device relating to any one of the first, third, fourth, fifth and sixth aspects has a structure in which each of the first imaging optical system and the second imaging optical system is a zoom lens, the storage unit preliminarily stores a focus positional deviation amount between the first lens position of the first focus lens and the second lens position of the second focus lens at the time of focusing on an identical subject for each of zoom positions of the zoom lenses, and upon calculating the second lens position, the focus adjusting unit reads out a focus positional deviation amount corresponding to the zoom position of the zoom lens, and calculates the second lens position based upon the focus positional deviation amount and the first lens position searched for.

Since the focus positional deviation amount between the first and second focus lenses at the time of focusing on an identical subject, which is caused by individual differences of the first and second imaging units, differs depending on zoom positions, the stereoscopic imaging device of the seventh aspect is designed such that, upon calculating the second lens position, a focus positional deviation amount corresponding to the zoom position is read out from the storage unit and based upon this focus positional deviation amount and the first lens position, the second lens is calculated.

In accordance with an eighth aspect, a method for automatically adjusting focal point of a stereoscopic imaging device that is provided with: a first imaging unit having a first imaging optical system including a first focus lens and a first imaging element that photoelectrically converts subject light to be imaged through the first imaging optical system, and outputs a first viewpoint image; a second imaging unit having a second imaging optical system including a second focus lens and a second imaging element that photoelectrically converts subject light to be imaged through the second imaging optical system, and outputs a second viewpoint image; and a storage unit that preliminarily stores a focus positional deviation amount between a first lens position of the first focus lens and a second lens position of the second focus lens at the time of focusing on an identical subject, includes the steps of: operating the first focus lens to carry out a search within a predetermined first search range so as to search for a first lens position of the first focus lens at which a subject to be imaged is brought into focus based upon the first viewpoint image acquired from the first imaging unit at the time of the searching operation; shifting the first focus lens to the first lens position searched for; determining a second search range narrower than the first search range that is located before and after the lens position of the second focus lens and corresponds to the first lens position searched for; operating the second focus lens to carry out a search within the second search range determined and a second lens position of the second focus lens is searched for based upon the second viewpoint image acquired from the second imaging unit at the time of the searching operation; calculating the second lens position based upon the first lens position searched for and the focus positional deviation amount stored in the storage unit; and if the second lens position is searched for and found, shifting the second focus lens to the second lens position, while if it is not possible to search for the second lens position, shifting the second focus lens to the second lens position calculated.

In accordance with a ninth aspect, a method for automatically adjusting the focal point of a stereoscopic imaging device that is provided with: a first imaging unit having a first imaging optical system including a first focus lens and a first imaging element that photoelectrically converts subject light to be imaged through the first imaging optical system, and outputs a first viewpoint image; and a second imaging unit having a second imaging optical system including a second focus lens and a second imaging element that photoelectrically converts subject light to be imaged through the second imaging optical system, and outputs a second viewpoint image, includes the steps of: operating the first focus lens to carry out a search within a predetermined first search range so as to search for a first lens position of the first focus lens at which a subject to be imaged is brought into focus based upon the first viewpoint image acquired from the first imaging unit at the time of the searching operation; shifting the first focus lens to the first lens position searched for; determining a second search range narrower than the first search range that is located before and after the lens position of the second focus lens and corresponds to the first lens position searched for; operating the second focus lens to carry out a search within the second search range determined to search for a second lens position of the second focus lens at which the subject to be imaged is brought into focus based upon the second viewpoint image acquired from the second imaging unit at the time of the searching operation; if it is not possible to search for the second lens position within the second search range, operating the second focus lens to again carry out a search within a third search range wider than the second search range to search for a second lens position of the second focus lens at which the subject to be imaged is brought into focus based upon a second viewpoint image acquired from the second imaging unit at the time of the searching operation; and shifting the second focus lens to the second lens position searched for.

In accordance with a tenth aspect, the method for automatically adjusting the focal point of a stereoscopic imaging device relating to the ninth aspect is further provided with the steps of: preliminarily storing a focus positional deviation amount between a first lens position of the first focus lens and a second lens position of the second focus lens at the time of focusing on an identical subject in a storage unit; if it is not possible to search for the second lens position within the third search range, calculating the second lens position based upon the first lens position searched for and the focus positional deviation amount stored in the storage unit; and shifting the second focus lens to the second lens position calculated.

In accordance with an eleventh aspect, the method for automatically adjusting the focal point of a stereoscopic imaging device relating to the ninth aspect is further provided with the steps of: preliminarily storing a focus positional deviation amount between a first lens position of the first focus lens and a second lens position of the second focus lens at the time of focusing on an identical subject in a storage unit; calculating a differential value between the first lens position searched for within the first search range and the second lens position searched for within the third search range; if the calculated differential value is greater than a predetermined amount, calculating the second lens position based upon the first lens position searched for and the focus positional deviation amount stored in the storage unit; and if the calculated differential value is greater than a predetermined amount, shifting the second focus lens to the second lens position calculated, in place of the second lens position searched for within the third search range.

In accordance with a twelfth aspect, the method for automatically adjusting the focal point of a stereoscopic imaging device relating to the ninth aspect is further provided with the steps of: preliminarily storing a focus positional deviation amount between a first lens position of the first focus lens and a second lens position of the second focus lens at the time of focusing on an identical subject in a storage unit; calculating a differential value between the first lens position searched for within the first search range and the second lens position searched for within the third search range; if the calculated differential value is greater than a predetermined amount, calculating the first lens position based upon the second lens position searched for and the focus positional deviation amount stored in the storage unit; and if the calculated differential value is greater than a predetermined amount, shifting the first focus lens to the first lens position calculated, in place of the first lens position searched for within first search range.

In accordance with a thirteenth aspect, in the method for automatically adjusting the focal point of a stereoscopic imaging device relating to the eleventh or twelfth aspect, the predetermined amount is determined based upon the focus positional deviation amount.

In accordance with a fourteenth aspect, in the method for automatically adjusting the focal point of a stereoscopic imaging device relating to any one of the eighth, tenth, eleventh, twelfth and thirteenth aspects, each of the first imaging optical system and the second imaging optical system is a zoom lens, the method for automatically adjusting the focal point is further provided with the steps of: storing a focus positional deviation amount between the first lens position of the first focus lens and the second lens position of the second focus lens at the time of focusing on an identical subject in a storage unit for each of zoom positions of the zoom lenses, and upon calculating the second lens position, reading out a focus positional deviation amount corresponding to the zoom position of the zoom lens from the storage unit, as well as calculating the second lens position based upon the focus positional deviation amount and the first lens position searched for.

### Advantageous Effects of Invention

In accordance with a technique relating to the contents of disclosure of the present disclosure, since by utilizing the results of an AF search in the first imaging unit, the search range of the second imaging unit is narrowed so as to carry out an AF search, the total period of time of the AF search can be shortened to improve the efficiency, and the focusing process can be carried out without being influenced by individual differences of the first and second imaging units.

In accordance with one aspect of the contents of the present disclosure, if a focusing position of the second imaging unit cannot be searched for, since the focusing position of the second focus lens is calculated based upon a focusing position of the first focus lens obtained by the AF search of the first imaging unit and a focus positional deviation amount of the first and second focus lenses preliminarily stored; therefore, it becomes possible to find the second focus lens with high precision.

Moreover, in accordance with another aspect of the contents of the present disclosure, since if it is not possible to search for the focusing position of the second imaging unit, the AF search is again carried out with the narrowed search range of the second imaging unit being expanded into a wide search range, it is possible to carry out the focusing process without being influenced by individual differences of the first and second imaging units.

### BRIEF DESCRIPTION OF DRAWINGS

FIG. 1A is an outside drawing (No. 1) of a stereoscopic imaging device in accordance with the contents of the present disclosure.

FIG. 1B is an outside drawing (No. 2) of the stereoscopic imaging device in accordance with the contents of the present disclosure.

FIG. 2 is a block diagram illustrating the inner structure of each of the stereoscopic imaging devices of FIG. 1A and FIG. 1B.

FIG. 3 is a flow chart showing a first embodiment of a method for automatically adjusting the focal point of a stereoscopic imaging device in accordance with the contents of the present disclosure.

FIG. 4A is a drawing (No. 1) that shows a first search range of a first focus lens, a second search range of a second focus lens, and a relationship between each of search positions and an AF evaluation value.

FIG. 4B is a drawing (No. 2) that shows a first search range of the first focus lens, a second search range of the second focus lens, and a relationship between each of search positions and an AF evaluation value.

FIG. 4C is a drawing (No. 3) that shows a first search range of the first focus lens, a second search range of the second focus lens, and a relationship between each of search positions and an AF evaluation value.

FIG. 5A is a flowchart (No. 1) showing a second embodiment of the method for automatically adjusting the focal point of a stereoscopic imaging device in accordance with the contents of the present disclosure.

FIG. 5B is a flowchart (No. 2) showing the second embodiment of the method for automatically adjusting the focal point of a stereoscopic imaging device in accordance with the contents of the present disclosure.

FIG. 6A is a drawing (No. 1) that shows a first search range of the first focus lens, a third search range of the second focus lens, and a relationship between each of search positions and an AF evaluation value.

FIG. 6B is a drawing (No. 2) that shows a first search range of the first focus lens, a third search range of the second focus lens, and a relationship between each of search positions and an AF evaluation value.

FIG. 7A is a flowchart (No. 1) showing a third embodiment of the method for automatically adjusting the focal point of a stereoscopic imaging device in accordance with the contents of the present disclosure.

FIG. 7B is a flowchart (No. 2) showing the third embodiment of the method for automatically adjusting the focal point of a stereoscopic imaging device in accordance with the contents of the present disclosure.

### DESCRIPTION OF EMBODIMENTS

Referring to attached Figures, the following description will discuss embodiments of a stereoscopic imaging device and a method for automatically adjusting the focal point of a stereoscopic imaging device in accordance with the contents of the present disclosure.

### [Outside View of Stereoscopic Imaging Device]

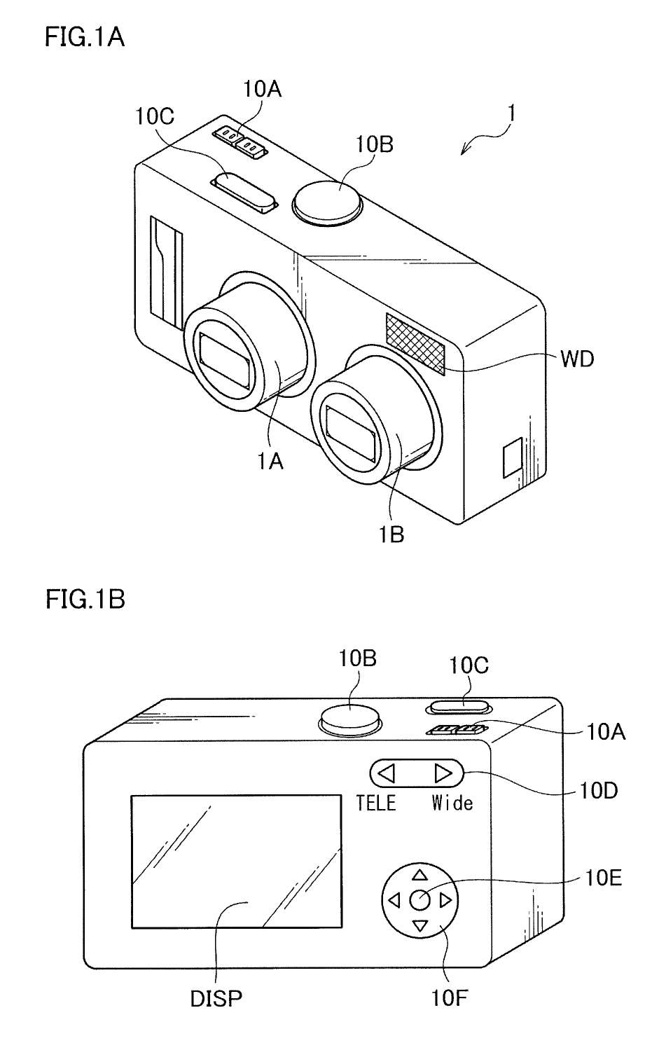

FIGS. 1A and 1B are outside drawings of a stereoscopic imaging device in accordance with the contents of the present disclosure, FIG. 1A is a perspective view in which a stereoscopic imaging device 1 is viewed diagonally from above, and FIG. 1B is a perspective view in which the stereoscopic imaging device 1 is viewed from its rear side.

As shown in FIG. 1A, the stereoscopic imaging device 1 has two imaging units 1A and 1B installed therein. In the following description, these two imaging units are referred to as a first imaging unit 1A and a second imaging unit 1B so as to be distinguished from each other.

The first imaging unit 1A and the second imaging unit 1B are disposed side by side so as to acquire an image signal for stereoscopic view, and image signals for right eye and left eye are respectively produced in these imaging units 1A and 1B. When a power switch 10A located on the upper surface of the stereoscopic imaging device 1 of FIGS. 1A and 1B is operated and a shutter button 10C is pushed, with an imaging mode dial 10B being set to, for example, a mode referred to as a stereoscopic mode, image data for stereoscopic view are generated in both of the imaging units 1A and 1B.

The shutter button 10C possessed by the stereoscopic imaging device 1 of the present embodiment has two operation modes, that is, a half push mode and a total push mode, and in this stereoscopic imaging device 1, when the shutter button 10C is half-pushed, an exposure adjustment and a focus adjustment are carried out, and when the shutter button is totally pushed, an image capturing operation is carried out. Moreover, a flash light emission window WD through which flash light is emitted to the subject to be imaged if the photographic field luminance is insufficient is installed above the imaging unit 1B.

Moreover, as shown in FIG. 1B, a liquid crystal monitor DISP capable of providing a stereoscopic display is installed on the rear surface of the stereoscopic imaging device 1, and on this liquid crystal monitor DISP, an identical subject to be imaged that is being captured by the two imaging units 1A and 1B is displayed as a stereoscopic image. In this case, as the liquid crystal monitor DISP, those monitors in which a lenticular lens and a parallax barrier are used and in which exclusively used glasses, such as polarizing glasses, liquid crystal shutter glasses and the like, are used so as to individually view an image for right eye and an image for left eye are used, may be adopted. Moreover, operation members, such as a zoom switch 10D, a menu/OK button 10E, a cross-key button 10F, etc. are also disposed. In the following description, those members, such as the power switch 10A, the mode dial 10B, the shutter button 10C, the zoom switch 10D, the menu/OK button 10E, the cross-key button 10F and the like, are sometimes generally referred to as an operation unit 10.

### [Inner Structure of Stereoscopic Imaging Device]

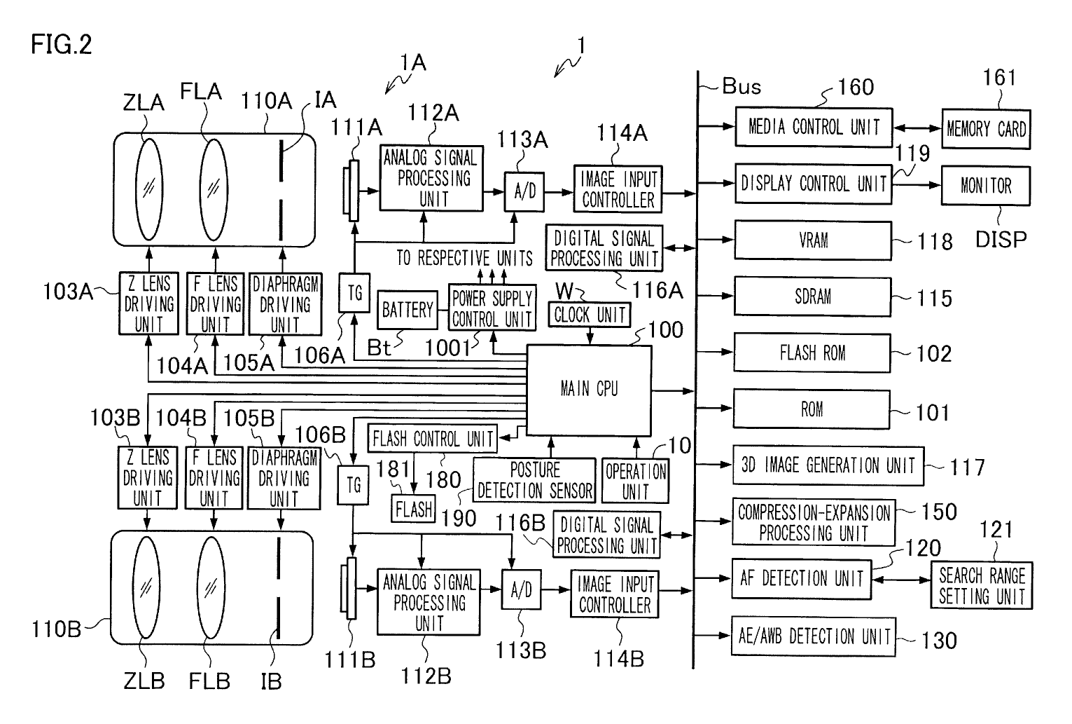

FIG. 2 is a block diagram illustrating the inner structure of a stereoscopic imaging device shown in FIG. 1A and FIG. 1B. Referring to FIG. 2, the following description will explain the inner structure of the stereoscopic imaging device 1.

Operations of the stereoscopic imaging device 1 are generally controlled by a main CPU 100.

A ROM 101 is connected to the main CPU 100 through a bus Bus, and a program required for operating the stereoscopic imaging device 1 is stored in the ROM 101. In accordance with the sequence of the program, the main CPU 100 generally controls the operations of the stereoscopic imaging device 1.

First, when the power switch 10A in the operation unit 10 shown in FIGS. 1A and 1B is operated, the main CPU 100 controls a power supply control unit 1001 to supply power to respective units of FIG. 2 from a buttery BT through the power control unit 1001, thereby shifting the stereoscopic imaging device 1 to an operating state. Thus, the main CPU 100 starts an image capturing operation. In this case, it is supposed that an AF detection unit 120, a search range setting unit 121, an AE/AWB detection unit 130, an image input controller 114A, a digital signal processing unit 116A and a 3D image generation unit 117 are constituted by processors, such as DSP's (Digital Signal Processors) and the like, and the main CPU 100 is supposed to carry out the processes in cooperation with the DSP's.

Referring to FIG. 2, the following description will explain the inner structures of the first imaging unit 1A and the second imaging unit 1B described earlier by reference to FIGS. 1A and 1B. Additionally, by adding the term “first” to the respective constituent members of the first imaging unit 1A as well as by adding the term “second” to the respective constituent members of the second imaging unit 1B, the explanation will be given.

In the first imaging unit 1A, a first imaging optical system 110A including a first focus lens FLA, a first focus lens driving unit 104A (hereinafter, referred to as a first F lens driving unit) that shifts the first focus lens FLA in an optical axis direction and a first imaging element 111A that receives subject light derived from a subject image formed in a first imaging optical system to generate an image signal representing the subject are installed. In the first imaging optical system 110A, in addition, a first diaphragm IA and a first diaphragm driving unit 105A for use in altering the aperture diameter of the first diaphragm IA are installed.

Moreover, the first imaging optical system 100A is prepared as a zoom lens, and a z-lens driving unit 103A for controlling the zoom lens to have a predetermined focal length is installed therein. Additionally, in FIG. 2, by using one lens ZL, the entire imaging optical system is schematically indicated as a zoom lens.

In the same manner as in the first imaging unit 1A, in the second imaging unit 1B, an imaging optical system including a second focus lens FLB, a second focus lens driving unit 104B (hereinafter, referred to as a second F lens driving unit) that shifts the second focus lens FLB in an optical axis direction and a second imaging element 111B that receives subject light derived from a subject image formed in a second imaging optical system to generate an image signal representing the subject are installed.

In these first imaging unit 1A and second imaging unit 1B, image signals for stereoscopic view are generated, that is, an image signal for right eye is generated in the first imaging unit 1A, and an image signal for left eye is generated in the second imaging unit 1B, respectively.

The first imaging unit 1A and the second imaging unit 1B have completely the same structure, and they differ from each other only as to whether an image signal for right eye or an image signal for lest eye is generated therefrom, and after the image signals of the two imaging units have been converted to digital signals in a first A/D conversion unit 113A and a second A/D conversion unit 113B and directed to the bus Bus, the same signal processing is carried out. Therefore, the following description will explain the structure in accordance with a flow of an image signal with respect to the first imaging unit 1A.

First, an operation that is carried out when a subject image captured by the first imaging unit 1A, as it is, is displayed on the liquid crystal monitor DISP as a through-the-lens image will be explained.

When the power switch 10A in the operation unit 10 is operated, the main CPU 100 controls the power control unit 1001 so as to supply power from the battery BT to respective units so that the stereoscopic imaging device 1 is brought into an operation state.

The main CPU 100 first controls the F lens driving unit 104A and the diaphragm driving unit 105A so as to start exposure and focus adjustments. Moreover, it gives an instruction to a timing generator (TG) 106A so that the imaging element 111A is allowed to set an exposure time determined by an electronic shutter; thus, an image signal is outputted from the imaging element 111A to an analog signal processing unit 112A, for example, every 1/60 second.

In the analog signal processing unit 112A, a timing signal is received from the TG106A, with the image signal being supplied from the imaging element 111A every 1/60 second, so that a noise reducing process and the like are carried out, and an analog image signal that has been subjected to the noise reducing process is supplied to the A/D conversion unit 113A in the next stage. In this A/D conversion unit 113A also, in synchronism with the timing signal from the TG 106A, a conversion process from the analog image signal to a digital image signal is carried out every 1/60 second. The digital image signal thus converted and outputted by the A/D conversion unit 113A is directed to the bus Bus every 1/60 second by an image input controller 114A so that the image signal directed to the bus Bus is stored in an SDRAM 115. Since the image signal is outputted from the imaging element 111A every 1/60 second, the contents of the SDRAM 115 are rewritten every 1/60 second.

The image signal stored in the SDRAM 115 is read out by the DSP forming the AF detection unit 120, the AE/AWB detection unit 130 and the digital signal processing unit 116A respectively, every 1/60 second.

In the AF detection unit 120, every 1/60 second in the middle of a period in which the main CPU 100 controls the F lens driving unit 104A so as to shift the focus lens FLA, a high frequency component of the image signal within a focus area is extracted, and the high frequency component is integrated so that an AF evaluation value indicating the contrast of an image is calculated. The main CPU 100 acquires the AF evaluation value calculated by the AF detection unit 120, and shifts the first focus lens FLA to a lens position (focusing position) that maximizes the AF evaluation value through the F lens driving unit 104A. For this reason, even when the first imaging unit 1A is directed in any direction, the focus is immediately adjusted so that a subject to be imaged is almost always displayed on the liquid monitor DISP in a good focused state.

Moreover, in the AE/AWB detection unit 130, the detection of subject luminance and calculations of a gain to be set in a white balance amplifier in the digital signal processing unit 116A are carried out every 1/60 second. Based upon the luminance detection result of the AE/AWB detection unit 130, the main CPU 100 controls the diaphragm driving unit 105A so that the aperture diameter of the diaphragm IA is altered. Moreover, by receiving the detection results from the AE/AWB detection unit 130, the digital signal processing unit 116A sets the gain of the white balance amplifier.

In the digital signal processing unit 116A, such a process as to form an image signal suitable for display is carried out, and the resulting image signal converted to be suitable for display by the signal processing in the digital signal processing unit 116A is supplied to a 3D image generation unit 117 so that an image signal for right eye for display is generated in the 3D image generation unit 117 and the image signal for right eye thus generated is stored in a VRAM 118.

The same operations as those mentioned above are also carried out by the second imaging unit 1B at the same timing. Therefore, two kinds of image signals for right eye and for left eye are stored in the VRAM 118.

The main CPU 100 transfers the image signal for right eye and the image signal for left eye in the VRAM 118 to the display control unit 119 so that an image is displayed on the liquid crystal monitor DISP. When the image signal for right eye and the image signal for left eye are displayed on the liquid monitor DISP in FIG. 1, an image on the liquid crystal monitor DISP can be seen stereoscopically to the human eye. Since the first and second imaging elements 111A and 111B continue to output the image signals every 1/60 second, the image signals in the VRAM 118 are rewritten every 1/60 second, and the stereoscopic image on the liquid crystal monitor DISP is also switched and displayed every 1/60 second so that the stereoscopic image is displayed as a dynamic image.

In this case, when, referring to the subject to be imaged on the liquid crystal monitor DISP, the shutter button 10C in the operation unit 10 is half-pushed, the main CPU 100 receives an AE value detected by the AE/AWB detection unit 130 immediately before the shutter button 10C has been totally pushed, and controls the first and second diaphragms IA and IB to be set to diaphragm diameters in accordance with the AE value through the first and second diaphragm driving units 105A and 105B, while shifting the first focus lens FLA within a first search range through the first lens driving unit 104A, so that the AF detection unit 120 is allowed to calculate the AF evaluation value.

Based upon the AF evaluation value calculated by the AF detection unit 120, the main CPU 100 detects a lens position (hereinafter, referred to as “first lens position P1”) of the first focus lens FLA that maximizes the AF evaluation value, and shifts the first focus lens FLA to this first lens position P1.

On the other hand, with respect to the second imaging optical system, the main CPU 100 shifts the second focus lens FLB within a second search range narrower than the first search range, and allows the AF detection unit 120 to calculate an AF evaluation value. The main CPU 100 receives the AF evaluation value from the AF detection unit 120, and detects a lens position (hereinafter, referred to as “second lens position P2”) of the second focus lens FLB that maximizes the AF evaluation value, and shifts the second focus lens FLB to this second lens position P2. Although the detailed description will be given later, at this time, the AF detection unit 120 allows a search range setting unit 121 to calculate a second search range narrower than the first search range centered on the lens position corresponding to the first lens position P1 of the first focus lens, based upon the first lens position P1 of the first focus lens FLA and data (near side deviation N and far side deviation F) indicating the search range read from a flash ROM 102, and the main CPU 100 receives the calculation results of the second search range, and carries out an AF search for retrieving the second lens position P2 (focusing position) within the second search range through the second F lens driving unit 104B.

In this manner, while the focus lens FLA of the first imaging unit 1A is allowed to carry out an AF search in the same manner as conventionally carried out, the second imaging unit 1B is allowed to carry out an AF search within a second search range that is narrower than the first search range including the lens position corresponding to the lens position of the first focus lens so that it is possible to shorten the period of AF search by the second focus lens FLB. Moreover, if the shutter button 10C is totally pushed, the main CPU 100 allows the first imaging element 111A and the second imaging element 111B to carry out exposing processes by predetermined shutter speeds through the first and second TG106A and TG106B so as to capture a still image. The main CPU 100 allows the first and second imaging elements 111A and 111B to output image signals to the first and second analog signal processing units 112A and 112B at the off-timing of the electronic shutter so that the first and second analog signal processing units 112A and 112B carry out a noise reducing process. Thereafter, an analog image signal is converted to a digital image signal in the first and second A/D conversion units 113A and 113B.

In this case, in accordance with an instruction from the main CPU 100, the first and second image input controllers 114A temporarily store the digital image signals converted by the first and second A/D conversion units 113A and 113B in the SDRAM 115 via the bus Bus. Thereafter, the digital signal processing units 116A and 116B read out the image signal from the SDRAM 115 and carry out image processings including a white balance correction, a gamma correction, a synchronization processing in which by interpolating spatial deviations of color signals such as R, G, B and the like caused by color filter arrangements of a single plate CCD, the positions of the respective color signals are adjusted, an outline correction, generations of luminance and color-difference signals (YC signal) and the like, so that the resulting signals are transmitted to the 3D image generation unit 117.

Successively, the main CPU 100 supplies the image signal for right eye and the image signal for left eye inside the 3D image generation unit 117 to a compression-expansion processing unit 150 by using the bus Bus. After the image data have been compressed by the compression-expansion processing unit 150, the main CPU 100 transfers the compressed image data to a media control unit by using the bus Bus, and simultaneously supplies header information relating to its compression and image capturing to the media control unit 160 so that the media control unit 160 is allowed to generate an image file in a predetermined format (for example, an image file of a MP (multipicture) format in the case of a 3D still image) and the image file is recorded in a memory card 161.

By the use of the structure of this embodiment, even if individual differences exist between the first imaging unit 1A and the second imaging unit 1B, since the first and second focus lenses are shifted to the first lens position P1 and the second lens position P2 at which focusing processes are carried out by executing AF searches respectively, the individual differences are eliminated, and the period of time for the AF operation including the AF search of the second focus lens FLB of the second imaging optical system can be shortened. Additionally, in FIG. 2, a flash control unit 180 and a flash 181 that executes a flash light emission through the light emission window WD of FIG. 1 upon receipt of an instruction from the flash control unit 180, as well as a clock unit W for use in detecting the current time and a posture detection sensor 190 for detecting the posture of the stereoscopic imaging device 1, are illustrated.

### First Embodiment

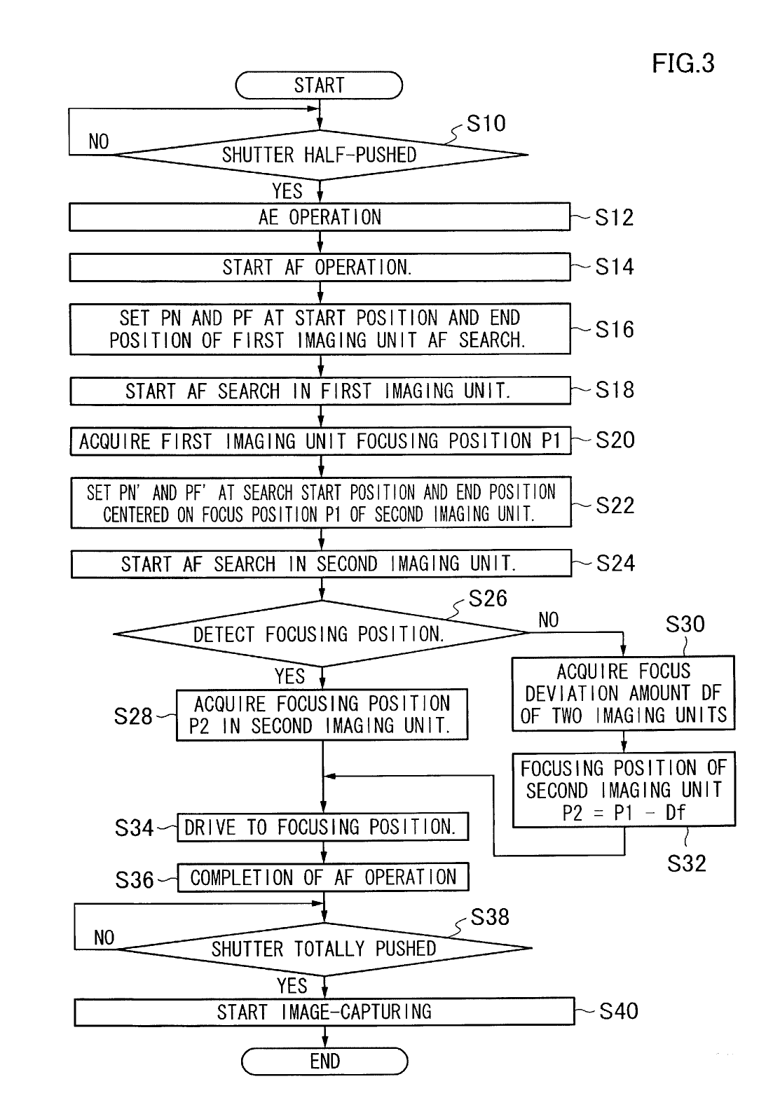

Referring to a flowchart shown in FIG. 3, the following description will discuss a first embodiment of a method for automatically adjusting the focal point of a stereoscopic imaging device in accordance with the contents of the present disclosure.

In FIG. 3, the main CPU 100 determines whether or not the shutter button 10C is half-pushed (step S10). Upon determination by the main CPU 100 that the shutter button 10C is not half-pushed, the sequence proceeds to the No side, thereby repeating the process of step S10; in contrast, upon determination in step S10 that the shutter button 10C is half-pushed, the sequence proceeds to the Yes side. If the sequence proceeds to the Yes side, upon receipt of an instruction for imaging preparation from the main CPU 100 in step S12, the AE/AWB detection unit 130 in the DSP starts an AE operation, and the sequence further proceeds to step S14 so that the AF detection unit 120 in the DSP starts an AF operation.

Upon starting the AF operation in step S14, the main CPU 100 first sets a first search range of the first focus lens FLA in step S16.

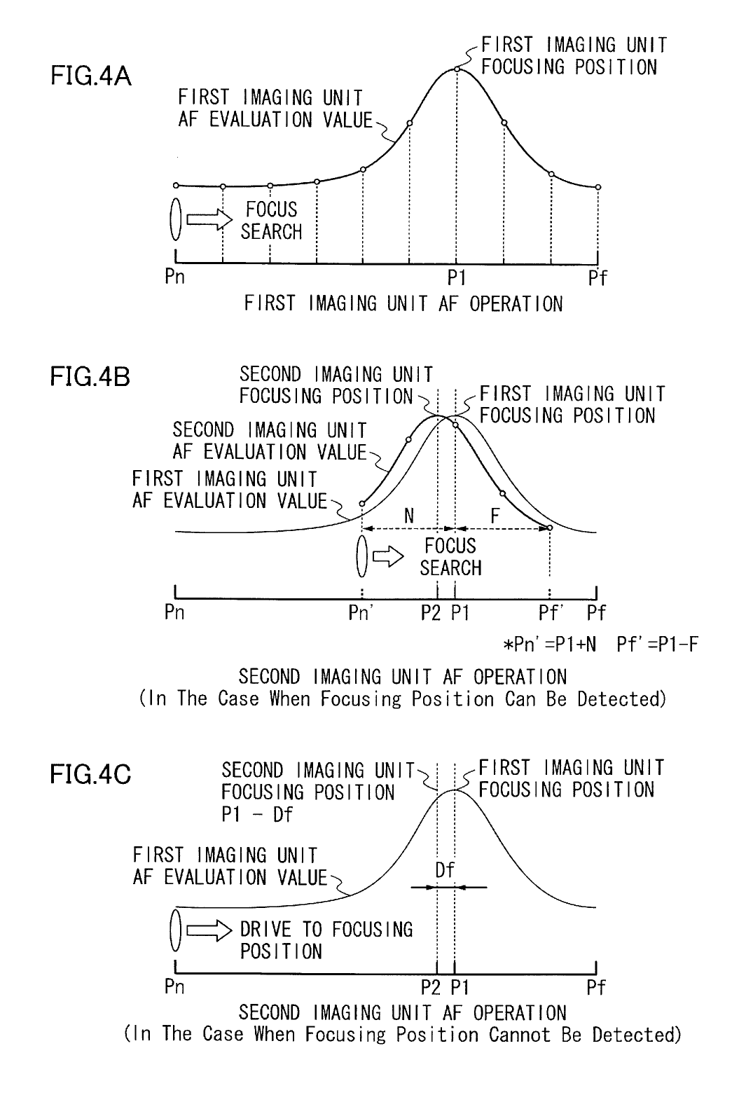

FIGS. 4A to 4C are drawings that indicate a relationship among the first search range of the first focus lens FLA, each of the search positions (the respective lens positions of the first focus lens FLA) and an AF evaluation value.

As shown in FIG. 4A, the first search range is, for example, from the nearest end (Pn) to the infinity end (Pf). Additionally, since the shifting range of the focus lens is deferent depending on the zoom magnification, the search range is set to a different range depending on the zoom magnification.

Next, in step S18, the main CPU 100 shifts the first focus lens FLA of the first imaging optical system within the first search range, and each time the first focus lens FLA reaches a predetermined lens position (if the focus lens FLA is pulse-driven, each time the driving operation is carried out by a predetermined number of pulses), acquires an AF evaluation value through the AF detection unit 120.

Next, based upon a plurality of lens positions before and after the lens position that maximizes the acquired AF evaluation value and the corresponding AF evaluation value, an approximation curve of the AF evaluation value that passes through the respective AF evaluation values, and a lens position P1 at which the approximation curve has a maximum value is obtained as a focusing position (step S20). Additionally, an arrangement may be prepared, in which upon AF searching within the first search range, if the AF evaluation value is reduced after an increase of the AF evaluation value, the searching operation is stopped so that the lens position P1 that maximizes the AF evaluation value can be calculated.

In the next step S22, the AF detection unit 120 supplies the lens position P1 to the search range setting unit 121, and simultaneously reads out search start position data N and search completion position data F from the flash ROM 102 and supplies these to the search range setting unit 121 so that the search range setting unit 121 is allowed to set a second search range that is narrower than the first search range centered on the lens position P1.

Supposing that the search start position is Pn′ and the search completion position is Pr as shown in FIG. 4B, the second search range is set as indicated by the following equation.

Pn′=P1+N, Pf′=P1−F [Equation 1]

Next, the main CPU 100 shifts the focus lens FLB within the second search range thus set, and each time the second focus lens FLB reaches a predetermined lens position, acquires the AF evaluation value through the AF detection unit 120 (step S24).

Moreover, the main CPU 100 determines whether or not a focusing position (second lens position P2) can be detected by the AF evaluation value acquired in step S24 (step S26). For example, if the contrast of an image is low, with the result that any of the acquired AF evaluation values do not reach a predetermined threshold value, or if they monotonically increase or monotonically decrease (no peak exists), it determines that no focusing position can be detected.

In step S26, upon determination that the focusing position can be detected, in the same manner as the acquisition of the first lens position P1, based upon a plurality of lens positions before and after the lens position that maximizes the AF evaluation value acquired in step S24 and the corresponding AF evaluation value, an approximation curve of the AF evaluation value that passes through the respective AF evaluation values, and a lens position P2 corresponding to a maximum value in the approximation curve is obtained as a focusing position (step S28).

In contrast, upon determination that no focusing position can be detected in step S26, the sequence proceeds to step S30.

In step S30, a focusing positional deviation amount Df (for example, a value obtained by reducing the number of pulses corresponding to the lens position of the second focus lens FLA from the number of pulses corresponding to the lens position of the first focus lens FLB) between the lens position of the first focus lens FLA and the lens position of the second focus lens FLB at the time of focusing on an identical subject is obtained from the flash ROM 102.

In the flash ROM 102, a focusing positional deviation amount Df between the lens position of the first focus lens FLA and the lens position of the second focus lens FLB at the time of focusing on an identical subject is preliminarily detected at the time of adjustments before delivery and the detected value is supposed to be stored.

Moreover, since the focusing positional deviation amount Df is also different depending on the zoom magnification (zoom position) of a zoom lens, the corresponding value is detected for each of zoom positions, and stored in the flash ROM 102. Therefore, in step S30, based upon the current zoom position of the zoom lens, the corresponding focus positional deviation amount Df is read out.

Next, as shown in FIG. 4C, based upon the first lens position P1 searched for by the AF search of the first focus lens FLA and the focus positional deviation amount Df acquired in step S30, a focusing position (second lens position) P2 of the second focus lens FLB is calculated from the following equation:

P2=P1−Df [Equation 2]

Then, the first focus lens FLA and the second focus lens FLB are respectively shifted to the first lens position P1 acquired in step S20 and the second lens position P2 acquired in step S28 or step S32; thus, the AF operation is completed (steps S34 and S36).

After the completion of the AF operation, the main CPU 100 determines whether or not the shutter button 10C is totally pushed (step S38). Upon determination by the main CPU 100 that the shutter button is not totally pushed in step S38, the sequence proceeds to the No side, thereby repeating the process of step S38; in contrast, upon determination that the shutter button is totally pushed, the sequence proceeds to the Yes side, thereby executing image capturing operations and completing this flow of processes.

Additionally, with respect to the second search range to be set before and after N and F centered on the first lens position P1 in the first embodiment, it can be determined by taking into consideration, for example, the focus positional deviation amount Df between the first focus lens FLA and the second focus lens FLB, as well as amounts of change (search margin portions) caused by temperatures, postures and the like. Moreover, in the first embodiment, the search range is set centered on the first lens position P1; however, the second search range may be set centered on the first lens position P1 (the second lens position P2 calculated in step S32) corrected by the focus positional deviation amount Df. This arrangement makes it possible to further narrow the second search range.

### Second Embodiment

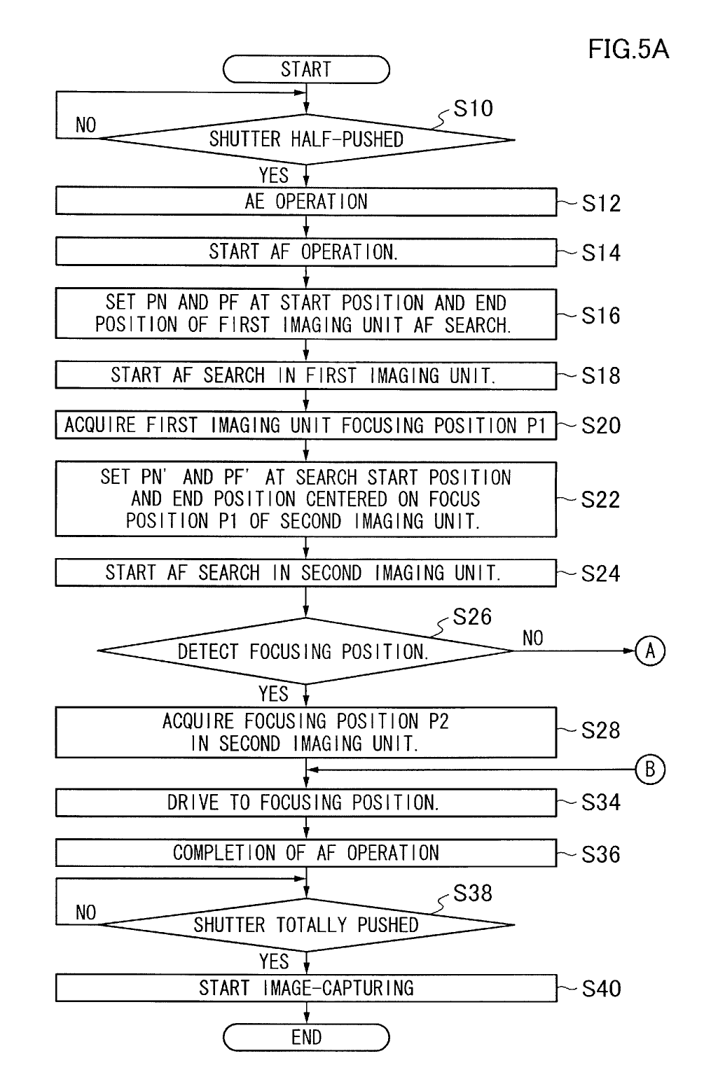

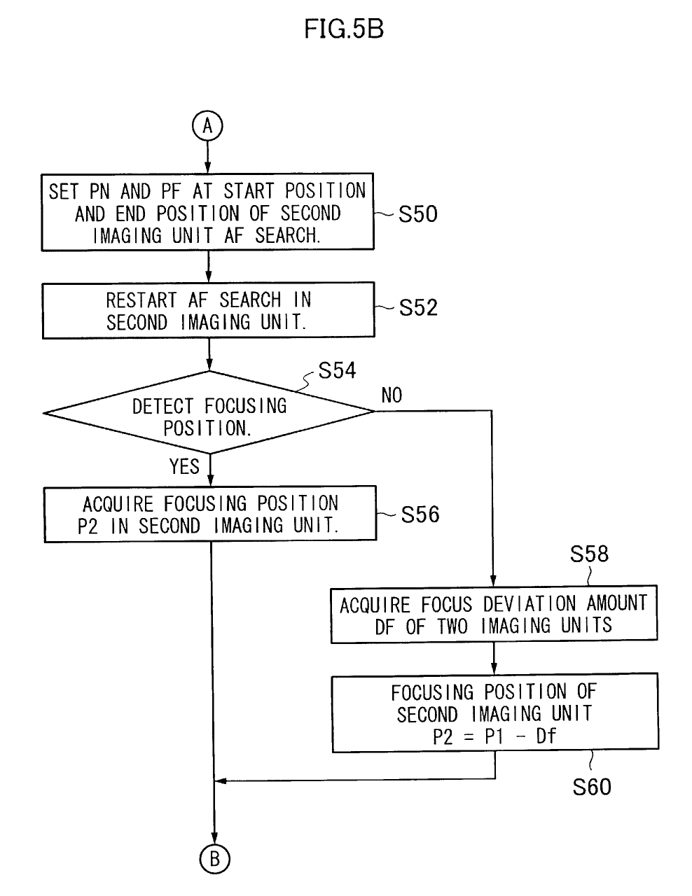

Referring to a flowchart shown in FIGS. 5A and 5B, the following description will discuss a second embodiment of a method for automatically adjusting the focal point of a stereoscopic imaging device in accordance with the contents of the present disclosure. Additionally, those portions that are in common with those of the flow chart of the first embodiment shown in FIG. 3 are indicated by the same step numbers, and the detailed description thereof will be omitted.

The second embodiment shown in FIGS. 5A and 5B is different in that a process shown in FIG. 5B is carried out in place of steps S30 and S32 shown in FIG. 3.

That is, upon determination that no focusing position (second lens position) of the second focus lens FLB can be detected in step S26 of FIG. 5A, the sequence proceeds to step S50 of FIG. 5B.

In step S50, in the same manner as in the first search range of the first focus lens FLA, as shown in Figure F6A, the search range from the nearest end (Pn) to the infinity end (Pf) is set as the search range (hereinafter, referred to as “a third search range”) of the second focus lens FLB. Additionally, the third search range may be set in such a range as to be wider than the second search range set in step S16, and narrower than the first search range.

By altering the search range from the second search range to the third search range as described above, the main CPU 100 again operates the second focus lens FLA to search within the third search range so that each time the second focus lens FLB reaches a predetermined lens position, an AF evaluation value is obtained through the AF detection unit 120 (step S52).

Based upon the AF evaluation value obtained in step S52, the main CPU 100 determines whether or not the focusing position (second lens position P2) can be detected (step S54).

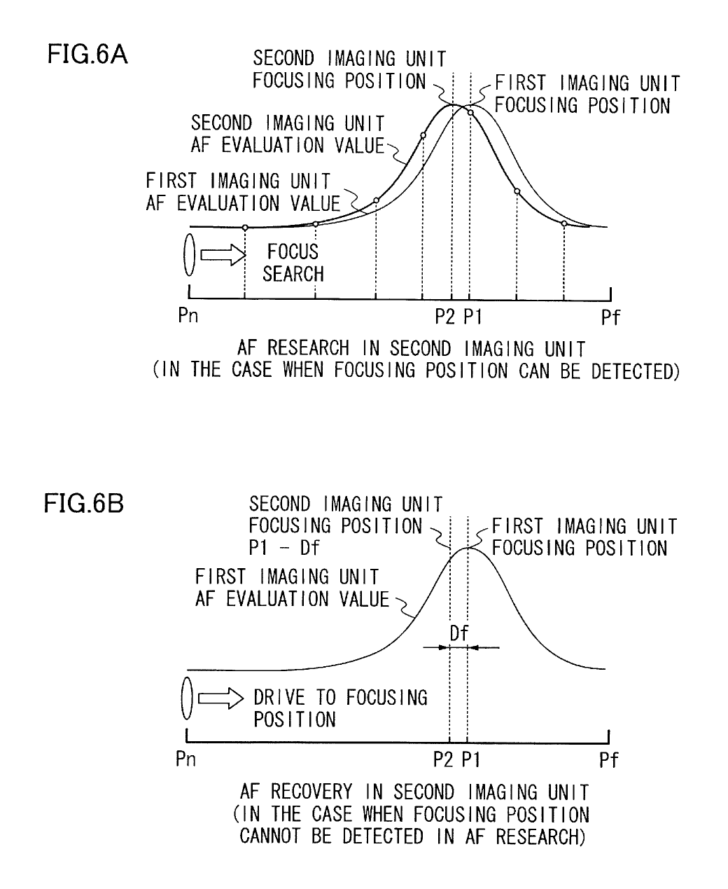

Upon determination that the second lens position can be detected (in the case of “Yes”), as shown in FIG. 6A, based upon a plurality of lens positions before and after the lens position that maximizes the acquired AF evaluation value and the corresponding AF evaluation value, an approximation curve of the AF evaluation value that passes through the respective AF evaluation values, and a lens position P2 at which the approximation curve has a maximum value is obtained as a focusing position (step S56). Thereafter, the sequence proceeds to step S34.

In contrast, upon determination that the second lens position can not be detected (in the case of “No”), the sequence proceeds to step S58 where a focus positional deviation amount Df is read out from the flash ROM 102.

Next, as shown in FIG. 6B, based upon the first lens position P1 searched for by the AF search of the first focus lens FLA and the focus positional deviation amount Df acquired in step S58, a focusing position (second lens position) P2 of the second focus lens FLB is calculated from the aforementioned equation 2 (step S60), and the sequence then proceeds to step S34.

In accordance with the second embodiment, if the focusing position (second lens position P2) of the second focus lens FLB cannot be detected within the second search range with a narrowed search range, the AF search is again carried out in the third search range with an expanded search range so that it becomes possible to detect the second lens position P2 with good precision. Although the efficiency of the AF operation becomes worse in this case, the total efficiency is not lowered so much because the possibility of determination in step S26 that the focusing position cannot be detected is small.

Moreover, if no focusing position is detected within the third search area (for example, although a subject to be imaged exists in the focus area of the first imaging unit, no subject to be imaged exists in the focus area of the second imaging unit), since the second lens position P2 is calculated based upon the first lens position P1 and the focus positional deviation amount Df, it becomes possible to adjust the focusing positions of the first focus lens FLA and the second focus lens FLB with high precision.

### Third Embodiment

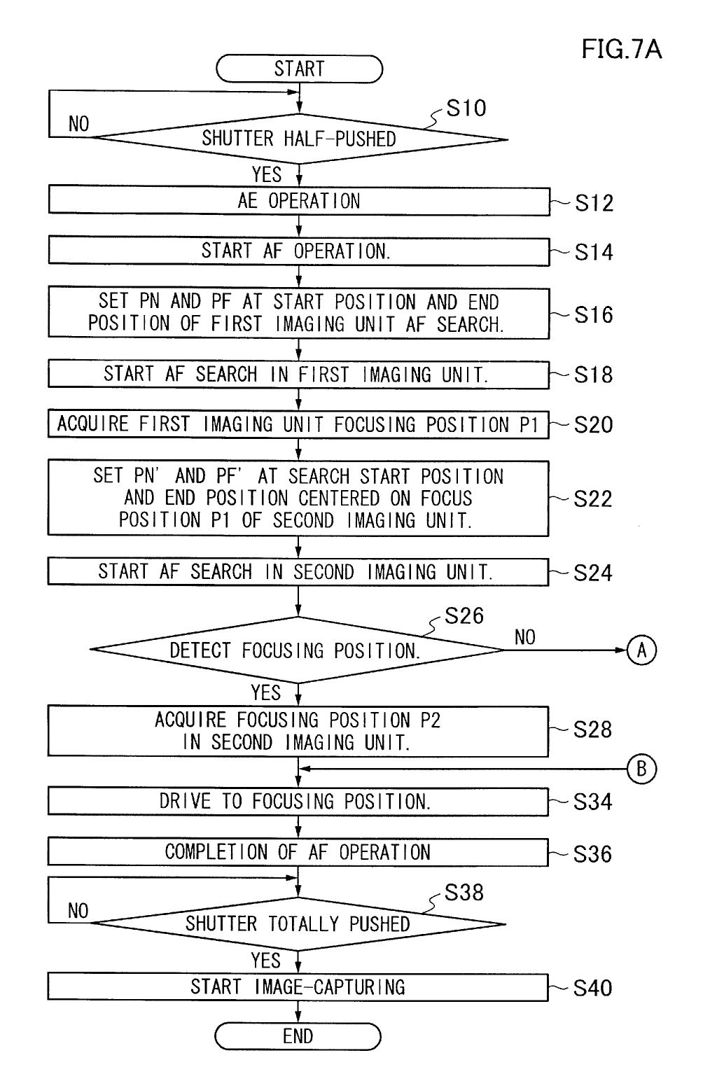

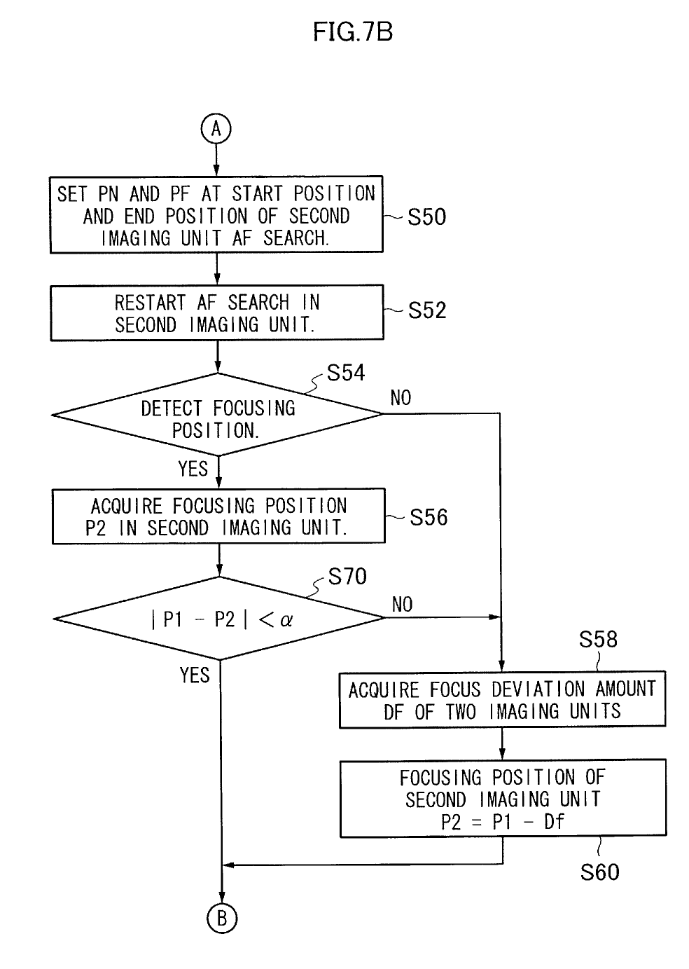

Referring to a flowchart shown in FIGS. 7A and 7B, the following description will discuss a third embodiment of a method for automatically adjusting the focal point of a stereoscopic imaging device in accordance with the contents of the present disclosure. Additionally, those portions that are in common with those of the flow chart of the second embodiment shown in FIGS. 5A and 5B are indicated by the same step numbers, and the detailed description thereof will be omitted.

The third embodiment shown in FIGS. 7A and 7B differs from the second embodiment in that as shown in FIG. 7B, a step S70 is added as a step succeeding to step S56 of FIG. 5B.

That is, when the focusing position (second lens position) P2 of the second focus lens FLB is acquired by step S56 of FIG. 7B, a differential value |P1−P2| between the lens position P1 of the first focus lens FLA acquired in step S20 and the second lens position P2 is calculated. If the calculated differential value |P1−P2| is smaller than a predetermined amount α (in the case of |P1−P2|<α), the sequence proceeds to step S34, while if it is greater than the predetermined amount α (in the case of |P1−P2|≧α), the sequence proceeds to step S58.

That is, in step S56, since the focusing position (second lens position) P2 is obtained from the third search range with a wide search range, there is a possibility that the first imaging unit 1A and the second imaging unit 1B might capture respectively different subjects to be imaged. Therefore, if the differential value between the lens positions P1 and P2 of the first focus lens FLA and the second focus lens FLB is greater than a predetermined amount α or more, the second lens position P2 that is calculated from the first lens position P1 and the focus positional deviation amount Df is used as the focusing position of the second focus lens FLB.

The predetermined amount α may be determined by taking into consideration the focus positional deviation amount Df and amounts of change due to temperatures and the like.

Furthermore, in the third embodiment, if the calculated differential value |P1−P2| is greater than the predetermined amount α (in the case of |P1−P2|≧α), the second lens position P2 that is calculated from the first lens position P1 and the focus positional deviation amount Df is used as the focusing position of the second focus lens FLB; however, in a reversed manner, from the second lens position P2 and the focus positional deviation amount Df, the first lens position P1 may be calculated from the following equation:

P1=P2+Df, [Equation 3]

and in place of the first lens position P1 obtained in step S20, the first lens position P1 calculated as described above may be used as the focusing position of the first focus lens FLA.

It is needless to say that the contents of the present disclosure are not limited to the above embodiments, but that various changes may be made within the scope not departing from the gist of the contents of the present disclosure.

### REFERENCE SIGNS LIST

1 . . . stereoscopic imaging device, 1A . . . first imaging unit, 1B . . . second imaging unit, 10 . . . operation unit, 100 . . . main CPU, 101 . . . ROM, 102 . . . flash ROM, 104A . . . first focus lens driving unit, 104B . . . second focus lens driving unit, 110A . . . first imaging optical system, 110B . . . second imaging optical system, 111A . . . first imaging element, 111B . . . second imaging element, 120 . . . AF detection unit, 121 . . . search range setting unit, FLA . . . first focus lens, FLB . . . second focus lens

1-14. (canceled)

15. A stereoscopic imaging device comprising:
a first imaging unit having a first imaging optical system including a first focus lens and a first imaging element that photoelectrically converts subject light to be imaged through the first imaging optical system, and outputs a first viewpoint image;
a second imaging unit having a second imaging optical system including a second focus lens and a second imaging element that photoelectrically converts subject light to be imaged through the second imaging optical system, and outputs a second viewpoint image;
a storage unit that preliminarily stores a focus positional deviation amount between a first lens position of the first focus lens and a second lens position of the second focus lens at the time of focusing on an identical subject;
a first focus adjusting unit that operates the first focus lens to carry out a search within a predetermined first search range, acquires a first lens position at which a subject to be imaged is brought into focus based upon the first viewpoint image acquired from the first imaging unit, and shifts the first focus lens to the first lens position;
a search range setting unit that sets a second search range narrower than the first search range that contains the lens position of the second focus lens corresponding to the first lens position that has been acquired;
a second focus adjusting unit that operates the second focus lens to carry out a search within the second search range and searches for a second lens position at which the subject to be imaged is brought into focus; and
a photographing unit that performs a photographing of the first viewpoint image and the second viewpoint image when a photographing instruction is inputted after the process by the first focus adjusting unit and the second focus adjusting unit,
wherein the second focus adjusting unit calculates the second lens position based upon the first lens position and the focus positional deviation amount stored in the storage unit, and shifts the second focus lens to the second lens position, if it is not possible to acquire the second lens position within the second search range as a result of the search.

16. A stereoscopic imaging device comprising:
a first imaging unit having a first imaging optical system including a first focus lens and a first imaging element that photoelectrically converts subject light to be imaged through the first imaging optical system, and outputs a first viewpoint image;
a second imaging unit having a second imaging optical system including a second focus lens and a second imaging element that photoelectrically converts subject light to be imaged through the second imaging optical system, and outputs a second viewpoint image;
a first focus adjusting unit that operates the first focus lens to carry out a search within a predetermined first search range, acquires a first lens position at which a subject to be imaged is brought into focus based upon the first viewpoint image acquired from the first imaging unit, and shifts the first focus lens to the first lens position;
a search range setting unit that sets a second search range narrower than the first search range that contains the lens position of the second focus lens corresponding to the acquired first lens position;
a second focus adjusting unit that operates the second focus lens to carry out a search within the second search range, searches for a second lens position at which the subject to be imaged is brought into focus, and, shifts the second focus lens to the second lens position; and
a photographing unit that performs a photographing of the first viewpoint image and the second viewpoint image when a photographing instruction is inputted after the process by the first focus adjusting unit and the second focus adjusting unit,
wherein the search range setting unit sets a third search range wider than the second search range, if it is not possible to acquire the second lens position within the second search range as a result of the search by the second focus adjusting unit,
and wherein the second focus adjusting unit again operates the second focus lens to carry out a search within the third search range, acquires a second lens position at which a subject to be imaged is brought into focus based upon the second viewpoint image acquired from the second imaging unit, and shifts the second focus lens to the second lens position.

17. The stereoscopic imaging device according to claim 16, further comprising:
a storage unit that preliminarily stores a focus positional deviation amount between a first lens position of the first focus lens and a second lens position of the second focus lens at the time of focusing on an identical subject,
wherein in the case when it is not possible to search for the second lens position within the third search range, the second focus adjusting unit calculates the second lens position based upon the first lens position searched for and the focus positional deviation amount stored in the storage unit, and shifts the second focus lens to the second lens position.

18. The stereoscopic imaging device according to claim 16, further comprising:
a storage unit that preliminarily stores a focus positional deviation amount between a first lens position of the first focus lens and a second lens position of the second focus lens at the time of focusing on an identical subject; and
a calculation unit that calculates a differential value between the first lens position searched for within the first search range and the second lens position searched for within the third search range,
wherein the second focus adjusting unit calculates the second lens position based upon the first lens position searched for and the focus positional deviation amount stored in the storage unit, and shifts the second focus lens to the calculated second lens position in place of the second lens position searched for within the third search range, if a differential value calculated by the calculation unit is greater than a predetermined amount.

19. The stereoscopic imaging device according to claim 16, further comprising:
a storage unit that preliminarily stores a focus positional deviation amount between a first lens position of the first focus lens and a second lens position of the second focus lens at the time of focusing on an identical subject; and
a calculation unit that calculates a differential value between the first lens position searched for within the first search range and the second lens position searched for within the third search range,
wherein the first focus adjusting unit calculates the first lens position based upon the second lens position searched for and the focus positional deviation amount stored in the storage unit, and shifts the first focus lens to the calculated first lens position in place of the first lens position searched for within the first search range, if a differential value calculated by the calculation unit is greater than a predetermined amount.

20. The stereoscopic imaging device according to claim 18, wherein the predetermined amount is determined based upon the focus positional deviation amount.

21. The stereoscopic imaging device according to claim 15, wherein each of the first imaging optical system and the second imaging optical system is a zoom lens, the storage unit preliminarily stores a focus positional deviation amount between the first lens position of the first focus lens and the second lens position of the second focus lens at the time of focusing on an identical subject for each of zoom positions of the zoom lenses, and upon calculating the second lens position, the second focus adjusting unit reads out a focus positional deviation amount corresponding to the zoom position of the zoom lens, and calculates the second lens position based upon the focus positional deviation amount and the first lens position searched for.

22. A method for automatically adjusting the focal point of a stereoscopic imaging device, comprising the steps of:
operating the first focus lens to carry out a search within a predetermined first search range, and acquires a first lens position of the first focus lens at which a subject to be imaged is brought into focus based upon the first viewpoint image acquired from a first imaging unit at the time of the searching operation;
shifting the first focus lens to the acquired first lens position;
determining a second search range narrower than the first search range that contains the lens position of the second focus lens corresponding to the acquired first lens position;
operating the second focus lens to carry out a search within the second search range determined, and searching for a second lens position of the second focus lens at which the subject to be imaged is brought into focus based upon the second viewpoint image acquired from a second imaging unit at the time of the searching operation;
calculating the second lens position based upon the acquired first lens position and the focus positional deviation amount stored in a storage unit, if is not possible to search for the second lens position as a result of the search;
shifting the second focus lens to the calculated second lens position; and
performing a photographing of the first viewpoint image and the second viewpoint image when a photographing instruction is inputted after the process of shifting the first focus lens and the process of shifting the second focus lens.

23. A method for automatically adjusting the focal point of a stereoscopic imaging device that comprises:
a first imaging unit having a first imaging optical system including a first focus lens and a first imaging element that photoelectrically converts subject light to be imaged through the first imaging optical system, and outputs a first viewpoint image; and
a second imaging unit having a second imaging optical system including a second focus lens and a second imaging element that photoelectrically converts subject light to be imaged through the second imaging optical system, and outputs a second viewpoint image, comprising the steps of:
operating the first focus lens to carry out a search within a predetermined first search range, and acquiring a first lens position of the first focus lens at which a subject to be imaged is brought into focus based upon the first viewpoint image acquired from the first imaging unit at the time of the searching operation;
shifting the acquired first focus lens to the first lens position;
determining a second search range narrower than the first search range that contains the lens position of the second focus lens corresponding to the acquired first lens position;
operating the second focus lens to carry out a search within the determined second search range, and searching for a second lens position of the second focus lens at which the subject to be imaged is brought into focus based upon the second viewpoint image acquired from the second imaging unit at the time of the searching operation;
setting a third search range wider than the second search range, if it is not possible to acquire the second lens position within the second search range as a result of the search; and
operating again the second focus lens to carry out a search within the third search range, and acquiring a second lens position of the second focus lens at which the subject to be imaged is brought into focus; and
shifting the second focus lens to the acquired second lens position; and
performing a photographing of the first viewpoint image and the second viewpoint image when a photographing instruction is inputted after the process of shifting the first focus lens and the process of shifting the second focus lens.

24. The method for automatically adjusting the focal point of a stereoscopic imaging device according to claim 23, further comprising the steps of:
preliminarily storing a focus positional deviation amount between a first lens position of the first focus lens and a second lens position of the second focus lens at the time of focusing on an identical subject in a storage unit;
calculating the second lens position based upon the acquired first lens position and the focus positional deviation amount stored in the storage unit, if it is not possible to search for the second lens position within the third search range; and
shifting the second focus lens to the calculated second lens position.

25. The method for automatically adjusting the focal point of a stereoscopic imaging device according to claim 23, further comprising the steps of:
preliminarily storing a focus positional deviation amount between a first lens position of the first focus lens and a second lens position of the second focus lens at the time of focusing on an identical subject in a storage unit;
calculating a differential value between the first lens position searched for within the first search range and the second lens position searched for within the third search range;
calculating the second lens position based upon the first lens position searched for and the focus positional deviation amount stored in the storage unit, if the calculated differential value is greater than a predetermined amount; and
shifting the second focus lens to the calculated second lens position in place of the second lens position searched for within the third search range, if the calculated differential value is greater than a predetermined amount.

26. The method for automatically adjusting the focal point of a stereoscopic imaging device according to claim 23, further comprising the steps of:
preliminarily storing a focus positional deviation amount between a first lens position of the first focus lens and a second lens position of the second focus lens at the time of focusing on an identical subject in a storage unit;
calculating a differential value between the first lens position searched for within the first search range and the second lens position searched for within the third search range;
calculating the first lens position based upon the second lens position searched for and the focus positional deviation amount stored in the storage unit, if the calculated differential value is greater than a predetermined amount; and
shifting the first focus lens to the calculated first lens position, in place of the first lens position searched for within first search range, if the calculated differential value is greater than a predetermined amount.

27. The method for automatically adjusting the focal point of a stereoscopic imaging device according to claim 25, wherein the predetermined amount is determined based upon the focus positional deviation amount.

28. The method for automatically adjusting the focal point of a stereoscopic imaging device according to claim 22, wherein each of the first imaging optical system and the second imaging optical system is a zoom lens, the method for automatically adjusting the focal point of a stereoscopic imaging device further comprising the steps of:
storing a focus positional deviation amount between the first lens position of the first focus lens and the second lens position of the second focus lens in a storage unit for each of zoom positions of the zoom lenses, and
upon calculating the second lens position, reading out a focus positional deviation amount corresponding to the zoom position of the zoom lens from the storage unit, and calculating the second lens position based upon the focus positional deviation amount and the first lens position searched for.
